(19) United States
(12) Patent Application Publication
(10) Pub. No.: US 2014/0040659 A1
(43) Pub. Date: Feb. 6, 2014

(54) SELECTION OF ONE OF FIRST AND SECOND LINKS BETWEEN FIRST AND SECOND NETWORK DEVICES

(71) Applicant: Gary Michael Wassermann, (US)

(72) Inventor: Gary Michael Wassermann, (US)

(21) Appl. No.: 13/563,156

(22) Filed: Jul. 31, 2012

(51) Int. Cl. G06F 15/173; G06F 11/20

(52) U.S. Cl. 714/4.21; 709/223; 714/4.2; 714/E11.073

(57) ABSTRACT

Embodiments herein relate to selection of one of first and second links between first and second network devices. The first link is to transmit the traffic between the first and second network devices directly and the second link is to transmit the traffic between the first and second network devices through a network appliance.

### BACKGROUND

Networks, such as local area networks (LAN) or wireless LANs (WLAN), may employ a network appliance between two network devices that direct traffic. The network devices may be switches or routers while the network appliance may provide a useful service, such as network acceleration or intrusion protection.

### BRIEF DESCRIPTION OF THE DRAWINGS

The following detailed description references the drawings, wherein:

FIG. 1 is an example block diagram of a first network device to direct traffic to a second network device via one of first and second links;

FIG. 2 is another example block diagram of a first network device to direct traffic to a second network device via one of first and second links;

FIG. 3 is an example block diagram of a computing device including instructions for selection of one of first and second links between first and second network devices; and

FIG. 4 is an example flowchart of a method for selection of one of first and second links between first and second network devices.

### DETAILED DESCRIPTION

Specific details are given in the following description to provide a thorough understanding of embodiments. However, it will be understood by one of ordinary skill in the art that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

Networks, such as local area networks (LAN) or wireless LANs (WLAN), may employ a network appliance between two network devices that direct traffic, such as routers or switches. The network appliance may provide a useful service, such as network acceleration or a firewall. However, the network appliance may also introduce a new point of failure. Should the network appliance fail, the two network devices may have to find a new path, thus altering the MAC tables of the network devices as well as changing the overall network topology.

Moreover, attempting to create a specialized network appliance that allows traffic to pass through it even if the specialized network appliance fails, may require expensive hardware and software integration, present timing issues and/or may create compatibility issues. For instance, the specialized network appliance may require a watchdog timer to periodically determine if software of the specialized network appliance is responsive along with hardware to bridge two network interface cards (NIC) of the specialized network appliance if the software fails. Also, using the specialized network appliance may create a need to modify other existing network appliances and/or the network devices of the network.

Moreover, the specialized network appliance still may not overcome a hardware failure, such as a failure of at least one of the NICs or a failure of a physical link connecting to the specialized network appliance itself. Also, the specialized network appliance may lack an auto-recover feature, such as an ability to undo bridging the NICs.

In addition, the network appliance may create an unnecessary bottleneck between the two network devices by having all the traffic pass through the network appliance when only some of the traffic, such as TCP traffic, may be relevant to the network appliance. For instance, the network appliance may not be able to handle the bandwidth that would otherwise flow unfettered through the two network devices, thus reducing throughput. Other solutions, such as adding separate specialized hardware, like a load balancer, may present similar problems to that of the specialized network appliance.

Embodiments herein relate to selection of one of first and second links between first and second network devices. For example, the first network device may include the first link, the second link and a traffic module. The first link is to the second network device and the second link is to a network appliance. The first and second network devices switch and/or direct traffic. The network appliance is to connect to the second network device and to modify or filter at least some of the traffic passing between the first and second network devices via the second link. The traffic module is to select one of the first and second links to transmit the traffic from the first network device to the second network device at a given time. The network layer topology is not changed if one of the first and second links fails.

Thus, embodiments may offer an additional link between the two network devices that bypasses the network appliance. As a result, throughput may be increased and a load on the network appliance may be decreased, without adding special-purpose hardware to the network appliance or introducing a new point of failure. Moreover, there may even be a lighter load on the two network devices because if one of the links fails, the first and second network devices may switch-over to the other link without changing the layer 3 or network topology of the network. For example, the two network devices would not need to flush MAC tables or process MAC moves and MAC learns, if one of the links fails.

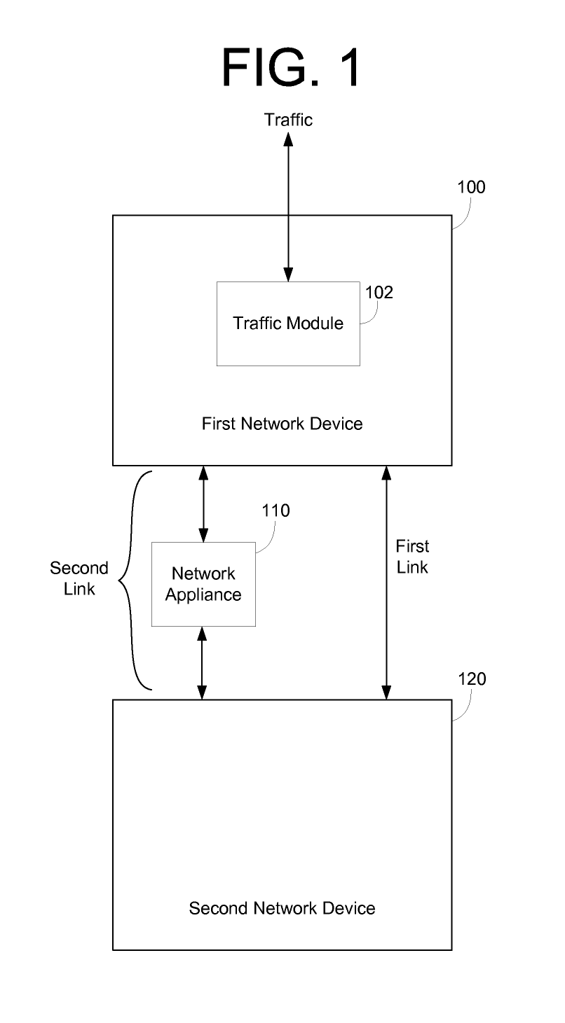

Referring now to the drawings, FIG. 1 is an example block diagram of a first network device 100 to direct traffic to a second network device 120 via one of first and second links. The first and second network devices 100 and 120 may be any type of device that connects network segments or network devices. For example, the first and second network devices 100 and 120 may be switches, hubs, routers, bridges, gateways, and the like. Further, the first and network devices 100 and 120 may switch and/or direct traffic.

The embodiment of FIG. 1 illustrates the first network device 100, a network appliance 110, and the second network device 120. The first network device 100 includes a traffic module 102. The traffic module 102 and the network appliance 110 may include, for example, a hardware device including electronic circuitry for implementing the functionality described below, such as control logic and/or memory. In addition or as an alternative, the traffic module 102 and the network appliance 110 may be implemented as a series of instructions encoded on a machine-readable storage medium and executable by a processor. Further, the traffic module 102 and the network appliance 110 may include mechanical, electrical and/or logical signals and a protocol for sequencing the signals.

The first network device 100 includes a first link to the second network device and a second link to the network appliance 110. The network appliance 110 is to connect to the second network device 120, and to modify at least some of the traffic passing between the first and second network devices 100 and 120 via the second link. The first and second links may represent any type of channel for connecting one location to another for the purpose of transmitting and receiving information, such as copper wires, optical fibers, and wireless communication channels.

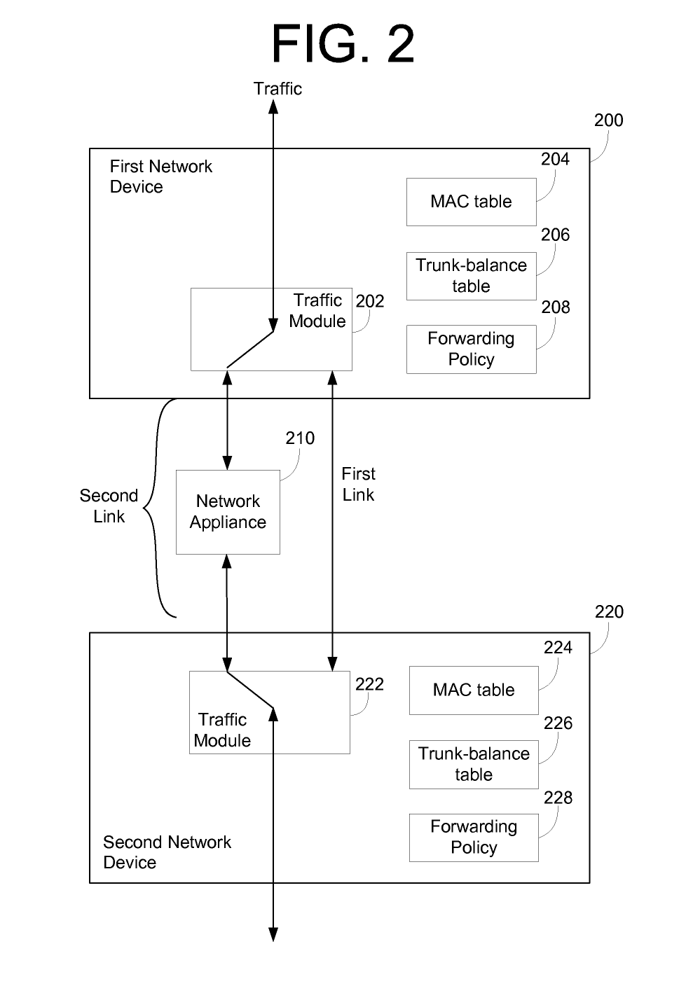

The traffic module 102 is to select one of the first and second links to transmit the traffic from the first network device 100 to the second network device 120 at a given time. Thus, the traffic module 102 may include a mechanism, such as a switch or multiplexer, to select between the two links. The traffic module 102 will be explained in greater detail below with respect to FIG. 2. Further, a network layer topology is not changed if one of the first and second links fails.

The network layer topology may refer to how data flows within a network, regardless of its physical design. For example, the network layer topology may refer to an arrangement of links between nodes at the network layer or layer 3 in a seven-layer OSI model of computer networking. The network layer may be responsible for packet forwarding including routing through intermediate routers, whereas a data link layer in the seven-layer OSI model may be responsible for media access control, flow control and error checking. The network layer may provide functional and procedural means of transferring variable length data sequences from a source to a destination host via one or more networks while maintaining the quality of service functions. In this instance, the traffic will still flow between the first and second network devices 100 and 120, even if one of the first and second links fails.

The network appliance 110 may be, for example, a network accelerator and/or a firewall device. The network accelerator, such as a local area network (LAN) or wireless LAN (WLAN) accelerator, may provide lower latency and higher throughput. For example, the network accelerator may enforce quality of service rules, compress data, compress IP headers, accelerate TCP, accelerate CIFS (Common Internet File System), mitigate lost packets with forward error correction, cache repeated data patterns at the byte level, and the like. The firewall device may keep a network secure. For example, the firewall device may control the incoming and outgoing network traffic by analyzing the data packets and determining whether the data packets should be allowed through or not, based on a predetermined rule set. The second network device 120 may be at least somewhat similar to the first network device 100.

FIG. 2 is another example block diagram of a first network device 200 to direct traffic to a second network device 220 via one of a first and second link. The first and second network devices 200 and 220 may be any type of device that connects network segments or network devices. For example, the first and second network devices 200 and 220 may be switches, hubs, routers, bridges, gateways, and the like. Further, the first and network devices 200 and 220 may switch and/or direct traffic.

The embodiment of FIG. 2 illustrates the first network device 200, a network appliance 210, and the second network device 220. The first network device 200, the network appliance 210, and the second network device 220 of FIG. 2 may at least respectively include the functionality and/or hardware of the first network device 100, the network appliance 110, and the second network device 120 of FIG. 1.

The first network device 200 is shown to include a traffic module 202, a MAC table 204, a trunk-balance table 206 and a forwarding policy module 208. The traffic module 202 of FIG. 2 may at least respectively include the functionality and/or hardware of the traffic module 102 of FIG. 1. The MAC table 204, the trunk-balance table 206 and the forwarding policy module 208 may include, for example, a hardware device including electronic circuitry for implementing the functionality described below, such as control logic and/or memory. In addition or as an alternative, the MAC table 204, the trunk-balance table 206 and the forwarding policy module 208 may be implemented as a series of instructions encoded on a machine-readable storage medium and executable by a processor and/or data stored on the machine-readable storage medium.

The second network device 220 is shown to include a traffic module 222, a MAC table 224, a trunk-balance table 226 and a forwarding policy module 228. The traffic module 222, the MAC table 224, the trunk-balance table 226 and the forwarding policy module 228 of the second network device 220 may at least respectively include the functionality and/or hardware of the traffic module 202, the MAC table 204, the trunk-balance table 206 and the forwarding policy module 208 of the first network device 200.

Referring to the first network device 200, in one embodiment, the traffic module 202 is to direct all the traffic to the second link but to redirect all the traffic from the second link to the first network link if the second link fails. Thus, the traffic module 202 may direct all the traffic to the second network device 220 through the network appliance 210, unless the second link fails, such as if the network appliance 210 malfunctions. In this case, the previously unused, first link may be selected by the traffic module 202 to transmit the traffic to the second network device 220, while the second link now remains unused.

However, should the second link recover, such as if the network appliance 210 is fixed or replaced, the traffic module 202 may redirect all the traffic from the first link back to the second link. In order to determine whether a link is healthy or has failed, the first network switch 200 may use a keep-alive mechanism, such as Bidirectional Forwarding Detection (BFD).

Further, in order to direct or redirect traffic to one the links, the first network switch 200 may reprogram the trunk-balance table 206. The trunk-balance table 206 may be a table used to select which of a trunk's or link aggregation's links a packet will egress on. For example, if the first network device 200 includes a plurality of physical ports, such as 48 physical ports, several of them, including the ports used for the first link and the second link, may be aggregated into a trunk, which is a single logical port. The trunk-balance table may then demultiplex network traffic to the trunk's members. Thus, reprogramming the trunk-balance table 206 may include redirecting traffic from one physical port to another within a logical port. The first network device 200 aggregates, at the data link layer, the traffic to be output to the second network device 220 along one of the first and second links.

In another embodiment, instead of transmitting all the traffic through one of the links, such as through the network appliance 210 via the second link, the traffic module 202 may determine which of the traffic to output to which of the first and second links based on a network forwarding policy, which may be stored at the forwarding policy module 208. The network forwarding policy may be based on numerous types of parameters. In one instance, the network forwarding policy is based on a type of the traffic. The traffic module 202 may output a first type of the traffic to one of the first and second links and to output a second type of the traffic to a reminder of the first and second links. The traffic module 202 may analyze a header of a packet to determine the type of the traffic.

For example, if the first type is Transmission Control Protocol (TCP) related data and the second type is non-TCP related data, the traffic module 202 may output the TCP related data to the second link and the non-TCP related data to the first link. This is because the network appliance 210 may be only be configured to analyze TCP related data. As a result, latency may be decreased, throughput may be increased, and a load on the network appliance 210 may be decreased.

In another instance, an active set of links that includes the first and second links may be maintained. Each of the links of the active set may be associated with a cost. The network forwarding policy may be based on the cost of the links of the active set. The traffic module 202 is to select one of the links from the active set of links to transmit the traffic from the first network device 200 to the second network device 220. For example, if the cost of the first link is 10 and a cost of the second link is 5, the traffic module 202 may select the lower cost link, such as the second link, to transmit the traffic from the first network device 200 to the second network device 220. If at least two links have a same cost, the traffic module 202 may select more than link, such as the at least two links having the same cost, to transmit the traffic from the first network device 200 to the second network device 220. Moreover, if one the links fails, the traffic module 202 may remove the failed link from the active set of links. Thus, the traffic module 202 would then not be able to select the failed link.

The media access control (MAC) table 204 may be a table that lists which MAC address is connected to which logical port of the first network device 200. The MAC address may be an identification number used in other machines, such as a serial number of a network card, switch and router, etc. Thus, the first network device 200 may reference its MAC table 204 and forward a packet or frame only to the logical port to which the destination is connected. The first network device 200 may receive information from previous transmissions with other network elements, such as the second network device 220, to build up its MAC table 204. Each of the network devices 200 and 220 may include separate MAC tables 204 and 224.

As noted above, the first network device 200 aggregates its physical ports used for the first and second links into one logical port at the data link layer. If a link carrying traffic fails, the first network device 200 may switch over to the other link without a change in the layer 3 or network topology of the network, because the path between first and second network devices remains intact. Thus, the MAC table 204 of the first network device 200 may retained even if the selected link fails and the traffic is redirected to the other of the first and second links. Also, an extra MAC learn and a MAC move are not processed by a processor (not shown) of the first network device 200 if the selected link fails and the traffic is redirected to the other of the first and second links.

As previously mentioned, the second network device 220 may be similar to the first network device 200. Thus, the traffic module 222 of the second network device 220 may also select one of the first and second links to transmit traffic from the second network device 220 to the first network device 200 at a given time. Further, the traffic module 222 of the second network device 220 may determine which of the traffic to output to which of the first and second links based on a network forwarding policy stored at the forwarding policy module 228.

For example, the first and second network devices 200 and 220 may both select one the first and second links to transmit traffic, if the network appliance 210 is a network accelerator, as bi-directional traffic may need to be processed. However, only one of the first and second network devices 200 and 220 may need to select one the first and second links to transmit traffic, if the network appliance is a firewall, because only unidirectional traffic, such as incoming or outgoing traffic, may need to be examined. While FIG. 2 shows only two links, embodiments may include more than two links between two network devices, and thus more than two members of the logical ports that are connected to an other network device.

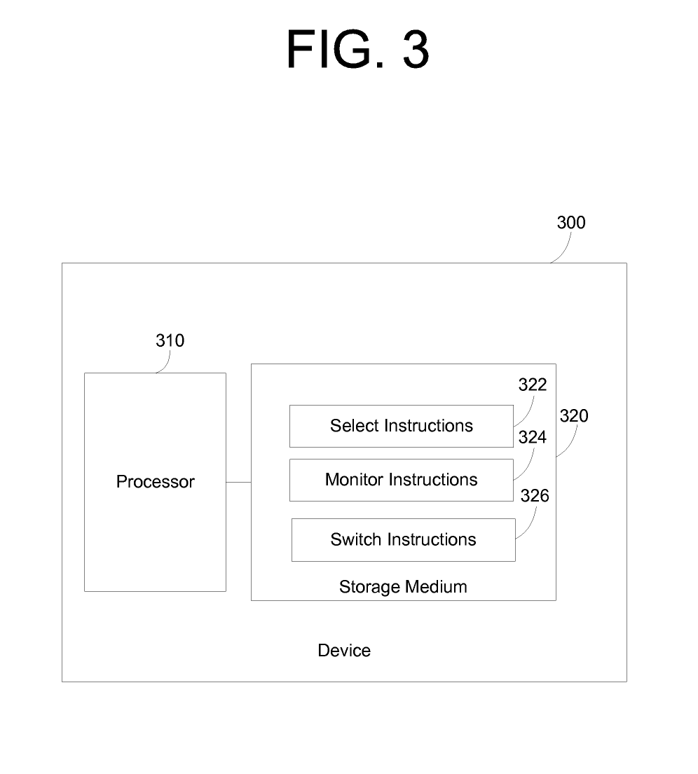

FIG. 3 is an example block diagram of a computing device 300 including instructions for selection of one of first and second links between first and second network devices. In the embodiment of FIG. 3, the computing device 300 includes a processor 310 and a machine-readable storage medium 320. The machine-readable storage medium 320 further includes instructions 322, 324 and 326 for selection of one of the first and second links between the first and second network devices. The computing device 300 may be, for example, a router, a switch, a gateway, a bridge or any other type of user device capable of executing the instructions 322, 324 and 326. In certain examples, the computing device 300 may be included or be connected to additional components such as a storage drive, a server, a network appliance, etc.

The processor 310 may be, at least one central processing unit (CPU), at least one semiconductor-based microprocessor, at least one graphics processing unit (GPU), other hardware devices suitable for retrieval and execution of instructions stored in the machine-readable storage medium 320, or combinations thereof. The processor 310 may fetch, decode, and execute instructions 322, 324 and 326 to implement for selection of one of the first and second links between the first and second network devices. As an alternative or in addition to retrieving and executing instructions, the processor 310 may include at least one integrated circuit (IC), other control logic, other electronic circuits, or combinations thereof that include a number of electronic components for performing the functionality of instructions 322, 324 and 326.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for selection of one of the first and second links between the first and second network devices.

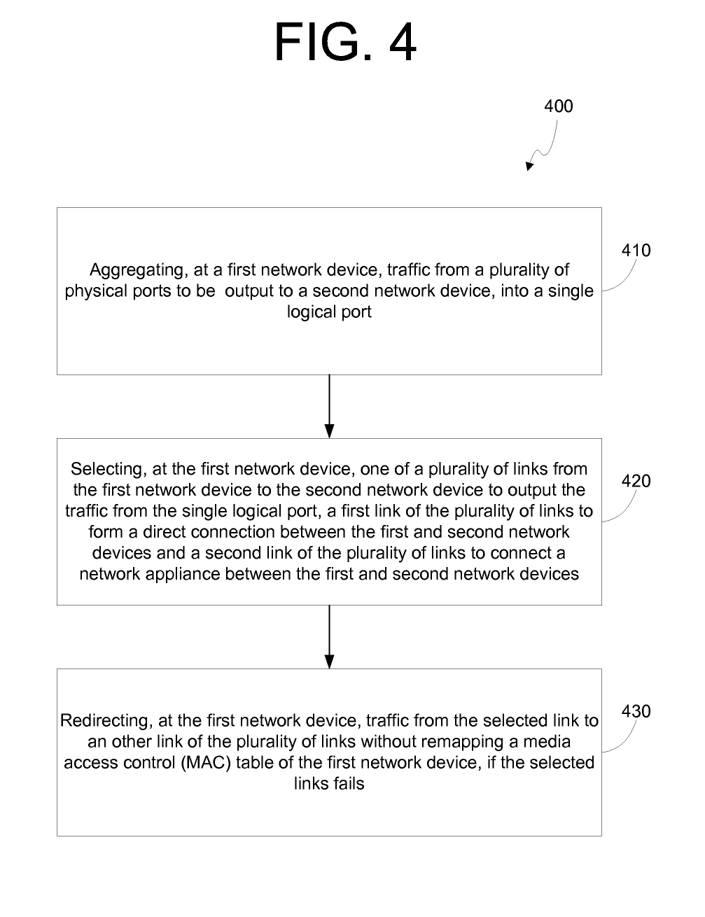

Moreover, the instructions 322, 324 and 326 when executed by a processor (e.g., via one processing element or multiple processing elements of the processor) can cause the processor to perform processes, such as, the process of FIG. 4. For example, the select instructions 322 may be executed by the processor 310 to select one of the first and second links to output traffic from the first network device (not shown) to the second network device (not shown). The first link is to transmit the traffic between the first and second network devices directly. The second link is to transmit the traffic between the first and second network device through a network appliance (not shown).

The monitor instructions 324 may be executed by the processor 310 to monitor the selected link for link failure. The switch instructions 326 may be executed by the processor 310 to switch selection from the selected link to an other of the first and second links without changing a network topology of the computing device 300, such as a network switch, if the selected links fails.

FIG. 4 is an example flowchart of a method 400 for selection of one of first and second links between first and second network devices. Although execution of the method 400 is described below with reference to the first network device 200, other suitable components for execution of the method 400 can be utilized, such as the first network device 100 and/or the second network device 220. Additionally, the components for executing the method 400 may be spread among multiple devices. The method 400 may be implemented in the form of executable instructions stored on a machine-readable storage medium, such as storage medium 320, and/or in the form of electronic circuitry.

At block 410, first network device 200 aggregates traffic from a plurality of physical ports of the first network device 200 to be output to a second network device 220, into a single logical port. Next, at block 420, the first network device 200 selects one of a plurality of links from the first network device to the second network device, to output the traffic from the single logical port. The first link of the plurality of links is to form a direct connection between the first and second network devices 200 and 220. A second link of the plurality of links is to connect a network appliance 210 between the first and second network devices 200 and 220. Then, at block 430, the first network device 200 redirects traffic from the selected link to an other link of the plurality of links without remapping a MAC table 204 of the first network device 200, if the selected links fails.

According to the foregoing, embodiments may provide a method and/or device for selection of one of first and second links between first and second network devices. By offering an additional link between the two network devices that bypasses the network appliance, throughput may be increased and load on the network appliance and network devices may be decreased, without adding special-purpose hardware to the network appliance or introducing a new point of failure. Moreover, if one of the links fails, the first and second network devices may switch-over to the other link without changing the layer 3 or network topology of the network.

We claim:

1. A first network device, comprising:
a first link to a second network device, the first and network devices to at least one of switch and direct traffic;
a second link to a network appliance, the network appliance to connect to the second network device and to at least one of modify and filter at least some of the traffic passing between the first and second network devices via the second link; and
a traffic module to select one of the first and second links to transmit the traffic from the first network device to the second network device at a given time, wherein
a network layer topology is not changed if one of the first and second links fails.

2. The first network device of claim 1, wherein the traffic module is to direct all the traffic to the second link and to redirect all the traffic from the second link to the first network link if the second link fails.

3. The first network device of claim 2, wherein,
the traffic module is to redirect all the traffic from the first link back to the second link if the second link recovers,
the first network switch includes a keep-alive mechanism to determine if at least one of first and second links has failed, and
the first network switch is to reprogram a trunk-balance table to redirect traffic from one of the first and second links to another of the first and second links.

4. The first network device of claim 1, wherein the traffic module is to determine which of the traffic to output to which of the first and second links based on a network forwarding policy.

5. The first network device of claim 4, wherein,
the network forwarding policy is based on a type of the traffic,
the traffic module is to output a first type of the traffic to one of the first and second links, and
the traffic module is to output a second type of the traffic to a remainder of the first and second links.

6. The first network device of claim 5, wherein the traffic module is to analyze a header of a packet to determine the type of the traffic.

7. The first network device of claim 6, wherein the first type is Transmission Control Protocol (TCP) related data and the second type is non-TCP related data.

8. The first network device of claim 4, further comprising:
an active set of links including the first and second links, each of the links of the active set associated with a cost, wherein
the network forwarding policy is based on the cost of the links of the active set,
the traffic module is to select one of the links from the active set of links to transmit the traffic from the first network device to the second network device, and
the traffic module is to remove a failed link from the active set of links.

9. The first network device of claim 4, wherein,
the second network device includes a traffic module to select one of the first and second links to transmit traffic from the second network device to the first network device at a given time, and
the traffic module of the second network device is to determine which of the traffic to output to which of the first and second links based on a network forwarding policy.

10. The first network device of claim 1, wherein,
the first network device includes a plurality of ports to output the traffic to the second network device, and
the first network device is to aggregate at the data link layer the traffic to be output to the second network device along one of the first and second links.

11. The first network device of claim 1, wherein,
the first and second network devices are switches, and
the media access control (MAC) table of the first network device is retained if the selected link fails and the traffic is redirected to the other of the first and second links.

12. The first network device of claim 11, wherein an extra MAC learn and a MAC move are not processed by a processor of the first network device if the selected link fails and the traffic is redirected to the other of the first and second links.

13. The first network device of claim 1, wherein,
the first and second network devices are at least one of a router and a switch, and
the network appliance is at least one of a network accelerator and a firewall device,
the first and second network devices are to select one the first and second links to transmit traffic, if the network appliance is a network accelerator, and
one of the first and second network devices are to select one the first and second links to transmit traffic, if the network appliance is a firewall.

14. A method, comprising:
aggregating, at a first network device, traffic from a plurality of physical ports to be output to a second network device, into a single logical port;
selecting, at the first network device, one of a plurality of links from the first network device to the second network device to output the traffic from the single logical port, a first link of the plurality of links to form a direct connection between the first and second network devices and a second link of the plurality of links to connect a network appliance between the first and second network devices; and
redirecting, at the first network device, traffic from the selected link to an other link of the plurality of links without remapping a media access control (MAC) table of the first network device, if the selected links fails.

15. A non-transitory computer-readable storage medium storing instructions that, if executed by a processor of a network switch, cause the processor to:
select one of first and second links to output traffic from a first network device to a second network device, the first link to transmit the traffic between the first and second network devices directly and the second link to transmit the traffic between the first and second network devices through a network appliance;
monitor the selected link for link failure; and
switch selection from the selected link to an other of the first and second links without changing a network topology of the network switch, if the selected links fails.
